(19) United States
(12) Patent Application Publication
(10) Pub. No.: US 2016/0027123 A1
(43) Pub. Date: Jan. 28, 2016

(54) AUTOMATIC TAGGING OF TRIAL BALANCE

(71) Applicant: Gastke Inc., San Francisco, CA (US)

(72) Inventors: Steven Riley Bong, San Francisco, CA (US); Gary Jude Bong, Walnut Creek, CA (US); Kevin Richard Bong, Walnut Creek, CA (US); Jason Paul Mitchell, Oakland, CA (US); William Russell Forrester, Berkeley, CA (US); Nicholas Jean Hanne, Walnut Creek, CA (US)

(21) Appl. No.: 14/338,260

(22) Filed: Jul. 22, 2014

(51) Int. Cl. G06Q 40/00; G06F 17/30

(52) U.S. Cl. CPC G06Q 40/12; G06F 17/30598

(57) ABSTRACT

Automatically tagging a trial balance is disclosed. The trial balance is received in a user specific format. Items in the trial balance are analyzed to identify a first item that likely corresponds to a first data grouping of a first data subset of the trial balance. Items in the trial balance are analyzed to identify a second item that likely corresponds to a second data grouping of a second data subset of the trial balance. Information is provided to display at least a portion of the first data subset of the trial balance identified as the first data grouping and to display at least a portion of the second data subset of the trial balance identified as the second data grouping to facilitate user verification of the identification of the first data subset as the first data grouping and the identification of the second data subset as the second data grouping.

### BACKGROUND OF THE INVENTION

When performing a financial audit, an auditor reviews financial accounts of an audit subject and performs procedures to ensure that financial records of the audit subject are accurate. A trial balance is a list of accounts of a subject. Often the trial balance includes a listing of account name, account number, current year account balance, previous year account balance, and a debit balance value or a credit balance value (e.g., part of double-entry bookkeeping). The trial balance may be used by an accountant to ensure that the total of all credits balances with the total of all debits in preparation of financial statements. When performing the audit of the audit subject, software tools may be utilized to track accounts of the audit subject. However, the software tool often requires a trial balance to be inputted to the software in a specific format predetermined by the software tool. Because each accountant may track and prepare trial balance information in various formats convenient to the accountant, the trial balance of the audit subject must be often manually converted by the accountant or an auditor to the specific format of the software tool to allow the software tool to input the trial balance information. This manual conversion process is often laborious (e.g., trial balance may contain hundreds of entries) and error prone. Therefore, there exists a need for a more flexible way to import trial balance information.

### BRIEF DESCRIPTION OF THE DRAWINGS

Various embodiments of the invention are disclosed in the following detailed description and the accompanying drawings.

FIG. 1 is a block diagram illustrating an embodiment of an audit processing environment.

FIG. 2 is a flowchart illustrating an embodiment of a process for processing a trial balance.

FIG. 3A is a diagram illustrating an embodiment of a user interface for providing a trial balance.

FIG. 3B is a diagram illustrating an embodiment of a user interface for providing a verification of identified data groupings.

FIG. 3C is a diagram illustrating an embodiment of a user interface for providing a verification of identified leadsheets associated with accounts of a trial balance.

FIG. 3D is a diagram illustrating an embodiment of a user interface for managing leadsheets.

FIG. 4 is a flowchart illustrating an embodiment of a process for automatically identifying a data grouping within a received user trial balance.

FIG. 5 is a flowchart illustrating an embodiment of a process for parsing a received trial balance using identified data groupings.

FIG. 6 is a flowchart illustrating an embodiment of a process for identifying a leadsheet.

FIG. 7 is a flowchart illustrating an embodiment of a process for identifying whether a data item is similar to an identifier pattern.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically tagging a trial balance is disclosed. In some embodiments, a trial balance is received in a user specific format. For example, a user provides a spreadsheet file of trial balance information formatted in a format desired by the user. Items in the trial balance are tested to identify a first item that likely corresponds to a first data grouping of a first data subset of the trial balance. For example, contents of a user provided spreadsheet with trial balance information are compared against a predetermined list of data classification/type identifiers to identify a column label that identifies content type (e.g., identify account name column, account number column, account balance column, etc.) of a particular column of the spreadsheet. Items in the trial balance are tested to also identify a second item that likely corresponds to a second data grouping of a second data subset of the trial balance. For example, another column label that identifies another content type in another particular column of the spreadsheet is identified. The first data grouping is displayed along with at least a portion of the first data grouping and the second data grouping is displayed along with at least a portion of the second data grouping. For example, a user is provided information that labels/tags portions (e.g., columns) of the trial balance with automatically identified data type column identifiers. If an automatically identified data grouping identifier has been incorrectly identified, a user may be able to correct the error by providing a correct data grouping identifier of an associated data grouping of the trial balance.

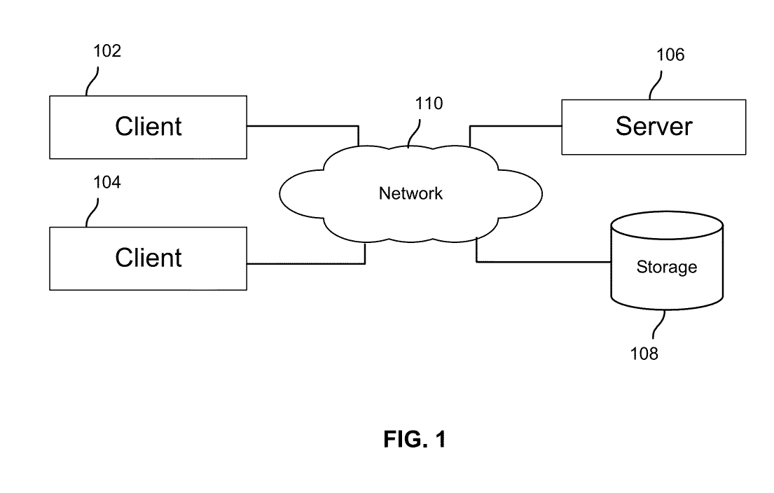

FIG. 1 is a block diagram illustrating an embodiment of an audit processing environment. Client device 102 and client device 104 are connected to server 106 via network 110. Server 106 stores content on storage 108 via network 110. In other embodiments, rather than being connected to network 110, storage 108 is directly connected to server 106 and/or a part of a different network. Examples of client device 102 and 104 include a personal computer, a desktop computer, an electronic reader, a laptop computer, a smartphone, a tablet computer, a mobile device, a wearable device, a wearable computer, and any other computer or electronic device. A user may utilize either device 102 or device 104 to access server 106. For example, a user may access a financial audit software service provided by server 106 via a web browser of a personal computer or a mobile application of a mobile device. Server 106 provides an audit software solution. For example, server 106 provides a network cloud-based service to manage, track, and perform a financial audit. Server 106 stores user data in storage 108. For example, server 106 stores financial information, audit data, and other related information of one or more users in storage 108. Examples of storage 108 include a storage drive, a networked storage, a database, or any other form of data storage.

In one example, the user of client device 102 utilizes device 102 to access, via network 110, a webpage provided by server 106. The user provides login information on the webpage and server 106 provides access to financial audit information and services accessible by the user. The user of one or more client devices may provide financial data of an audit subject and server 106 processes the provided information to automatically recognize and parse the provided financial data for use in an audit. For example, user provided information is parsed and placed in an internal data structure of server 106 (e.g., in a data structure stored in storage 108) for use in electronically tracking, managing, and performing a financial audit.

Examples of network 110 include one or more of the following: a direct or indirect physical communication connection, mobile communication network, a cellular network, a wireless network, Internet, intranet, Local Area Network, Wide Area Network, Storage Area Network, and any other form of connecting two or more systems, components, or storage devices together. In various embodiments, the components shown in FIG. 1 may exist in various combinations of hardware machines. For example, server 106 and storage 108 may be included in the same physical device. Other communication paths may exist and the example of FIG. 1 has been simplified to illustrate the example clearly. For example, server 106 and storage 108 are directly connected. Although single instances of components have been shown to simplify the diagram, additional instances of any of the components shown in FIG. 1 may exist. For example, server 106 may represent a group of servers and storage 108 may represent a storage cluster. Although two client devices 102 and 104 are shown, other client devices that belong to the same or different user of client devices 102 and 104 may exist. Components not shown in FIG. 1 may also exist to perform and provide functions and services described in this document.

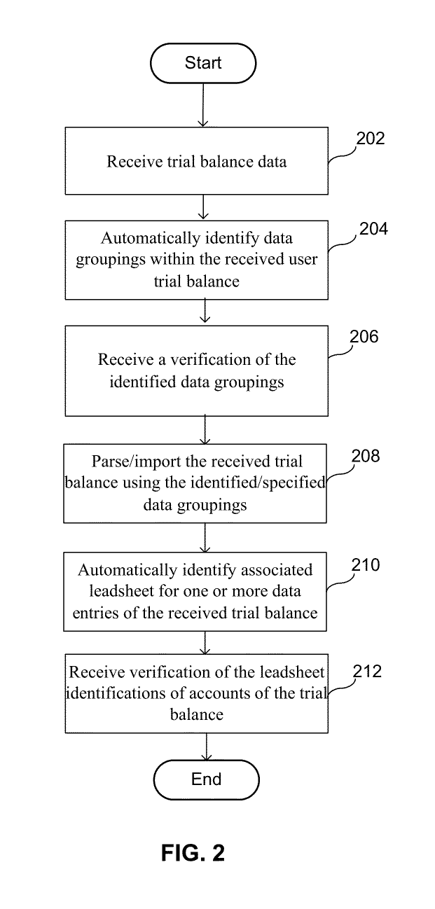

FIG. 2 is a flowchart illustrating an embodiment of a process for processing a trial balance. The process of FIG. 2 may be implemented on server 106 and/or client device 102/104 of FIG. 1.

At 202, trial balance data is received. For example, a user uploads a spreadsheet file with trail balance data to a server for processing. In some embodiments, receiving the trial balance includes receiving one or more of the following: a spreadsheet (e.g., Microsoft Excel spreadsheet format, OpenDocument Spreadsheet format, comma-separated values format, etc.), a table, database records, and accounting software data. In some embodiments, the trial balance lists accounts of an entity (e.g., audit subject) and their account balances. The trial balance may include other information such as account name, account number, current year balance, previous year balance, associated entity/fund, current year credit, current year debit, previous year credit, previous year debit, and/or associated leadsheet identifier. The trial balance may be prepared by an accountant and provided to an auditor, and the auditor may provide the trial balance to an audit software/service to perform auditing using the audit software/service. The trial balance may be utilized to verify that all credits equal all debits. In some embodiments, the received trial balance is indicated as including additional account entries to be uploaded/imported/added in addition to accounts specified in a previously received and processed trial balance.

In some embodiments, receiving the trial balance includes receiving the trial balance via a network. For example, a user uploads the trial balance using an application that provides the trial balance to a server via a network for processing. In some embodiments, receiving the trial balance includes receiving the trial balance on an audit software provided on a software-as-a-service (SAAS) platform. For example, the trial balance is provided to a network server for storage and processing. In some embodiments, the trial balance is formatted in a user specific format. For example, the trial balance has been formatted/organized in a format created by the accountant of the entity of the trial balance. Various different user specific formats may utilize different labeling conventions, different data ordering, different types of included data, different numeric formatting, different spacing, different totaling conventions, etc. By allowing a user specific format trial balance to be provided rather than forcing a single trial balance format convention, a user providing the trial balance does not need to perform tedious manual conversions of trial balance formats. However, the system receiving the user specific format trial balance needs to perform special processing to comprehend the received trial balance that is not in a predetermined format. In some embodiments, the provided trial balance is required to follow a minimal constraint (e.g., specification of minimum type(s) of data required for each account included in the trial balance). For example, each account included in the trial balance is required to specify at least an account name, an account number, and/or a current account balance. In some embodiments, the trial balance is received from client 102 at server 106 via network 110 of FIG. 1.

In some embodiments, the received trial balance is indicated as including one or more replacement account entries that replace/correct one or more account entries of a previously received and processed trial balance. For example, if it is detected (e.g., account number/name/fund/entity match) that the received trial balance data includes an entry for an account that has been already imported/added from processing a previously received trial balance, account information associated with the previously received trial balance is removed/replaced with account information of the newly received trial balance and a user is provided an indication (e.g., in a list of imported/added/detected accounts of the trial balance) that the replacement has been detected. In some embodiments, the received trial balance is indicated as replacing an entire previously received trial balance and all account information imported/added/detected from the previously received trial balance is deleted/removed before importing/adding/detecting data of the newly received trial balance.

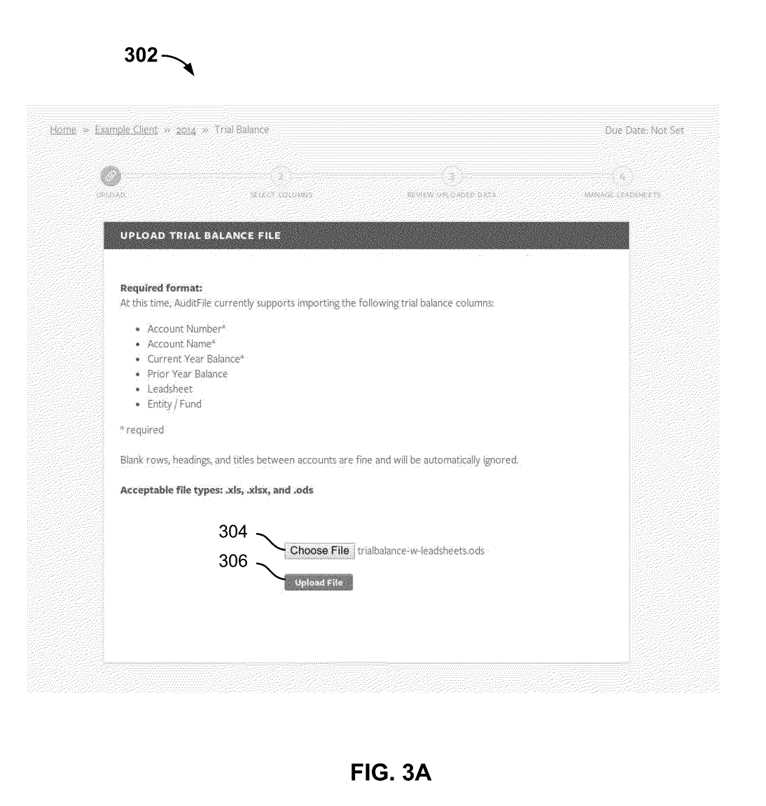

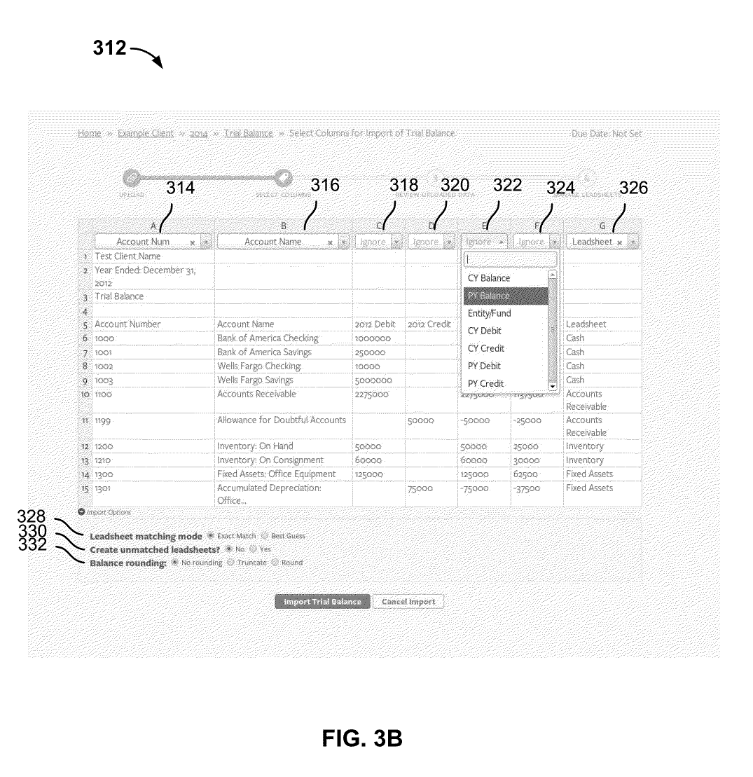

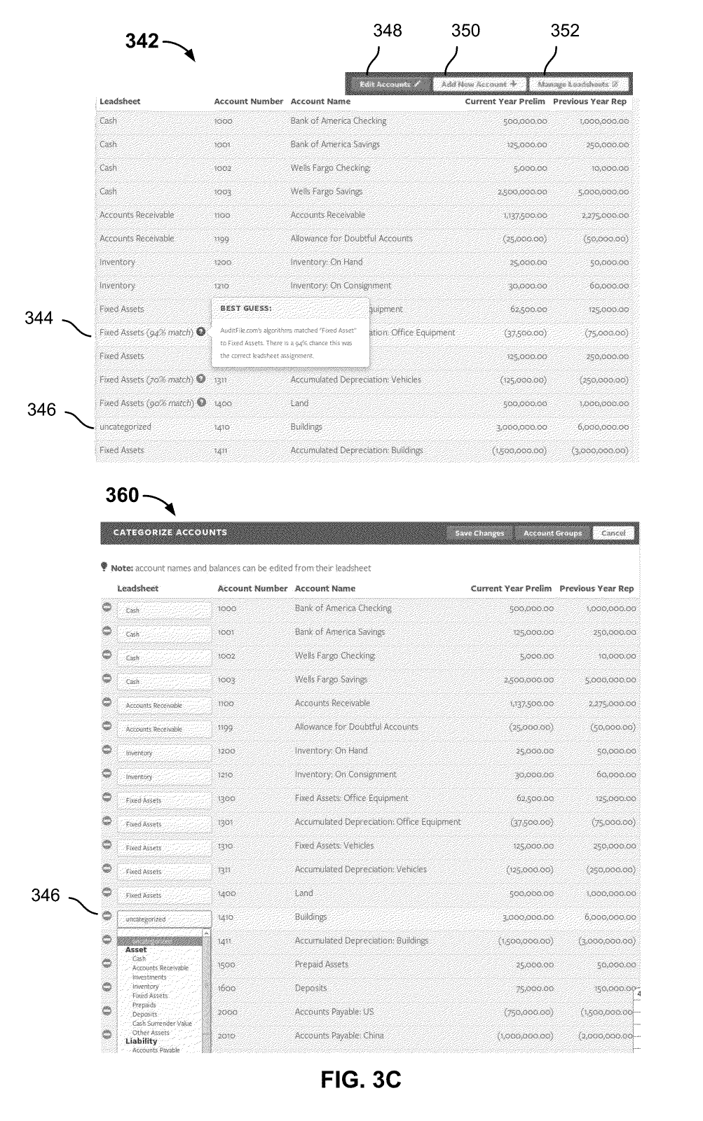

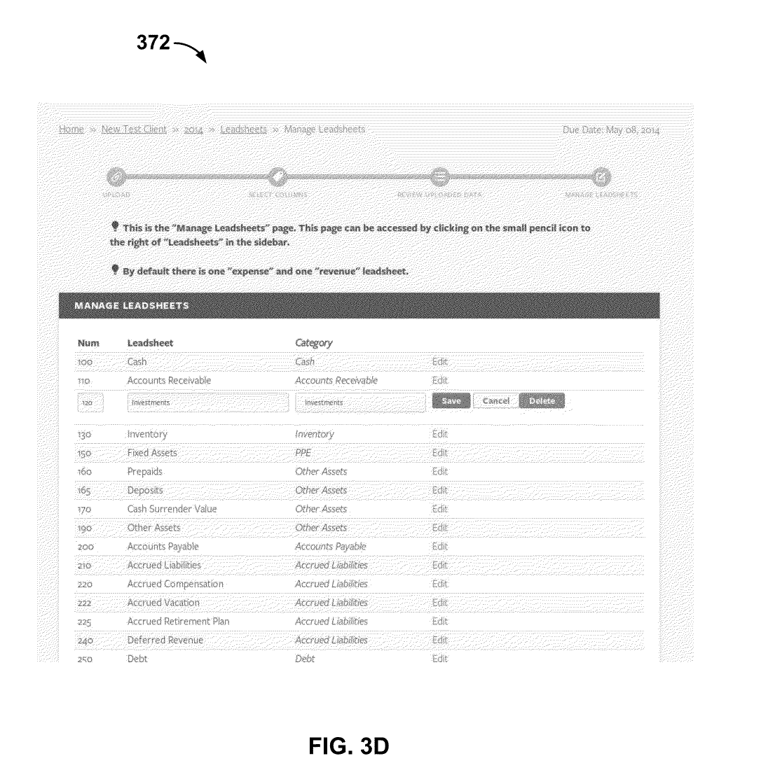

FIG. 3A is a diagram illustrating an embodiment of a user interface for providing a trial balance. For example, a user of user system 102 and/or 104 of FIG. 1 is provided interface 302 using data provided from server 106 of FIG. 1 to provide the trial balance received in 202 of FIG. 2. Interface 302 shows instructions regarding a type of trial balance file accepted by an audit software and provides button 304 that allows a user to select a file stored on a user storage (e.g., storage of user system 102/104 of FIG. 1) to be provided to the audit software. When a user selects button 306, the trial balance file selected using button 304 is provided to an audit software for processing. For example, the selected content is provided to a server via a network (e.g., network 110 of FIG. 1) for processing at a server (e.g., server 106 of FIG. 1).

Returning to FIG. 2, at 204, data groupings within the received user trial balance are automatically identified. For example, the received trial balance includes column heading identifiers that identify type of data in the corresponding column and the one or more column heading identifiers are automatically identified as corresponding to a respective known predetermined category of data. In some embodiments, a data grouping includes a column of a spreadsheet/table. In some embodiments, identifying a data grouping includes identifying an entry in the received trial balance as a column heading identifier that corresponds to one of one or more predetermined types of trial balance data recognizable by an audit software. For example, the following types of trial balance data are recognizable by an audit software: account name, account number, current year balance, previous year balance, associated entity/fund, current year credit, current year debit, previous year credit, previous year debit, and/or associated leadsheet identifier. For each type of trial balance data type, one or more character patterns (e.g., character string permutations of known possible identifiers) that correspond to the specific trial balance data type may be predetermined. Data items (e.g., spreadsheet cell content) of the received trial balance may be analyzed to identify whether any of the data items match these character patterns or are sufficiently similar to these characters patterns. If a match or a close match is found, the data grouping (e.g., column/row of a spreadsheet, row, database record grouping, etc.), may be identified as a known trial balance data type grouping.

In some embodiments, if an exact match or a close match is found, one or more other entries within the data grouping of the match are tested to verify that a correct trial balance data type grouping has been identified. For example, if a match to a current year balance column identifier has been found, one or more other cells of the column of the match are tested to verify that these cells include a numerical number (e.g., a predetermined percentage of cells pass the test) before the column of the match is identified as the current year balance column in a trial balance spreadsheet.

At 206, a verification of the identified data groupings is received. For example, automatically identified columns are provided (e.g., provided to a user device) for display to a user. The user may verify that the data groupings have been correctly identified by the automated identifier, correct any identification errors, or identify any new data groupings. For example, a user is provided information that labels/tags portions of the trial balance with automatically identified data type column identifiers. If an automatically identified data grouping identifier has been incorrectly identified or any data grouping was unable to be automatically identified, a user may be able to correct the error by providing a correct data grouping identifier of an associated data grouping of the trial balance. For example, for each column in the received trial balance, a drop down menu or another selection menu is provided to enable a user to provide/correct/verify a trial balance data type grouping associated with the column.

FIG. 3B is a diagram illustrating an embodiment of a user interface for providing a verification of identified data groupings. For example, a user of user system 102 and/or 104 of FIG. 1 is provided interface 312 using data provided from server 106 of FIG. 1 to receive verification of the identified data groupings received in 204 of FIG. 2. Interface 312 shows the first fifteen rows and seven columns of a received trial balance that have been analyzed. For example, the trial balance received in 202 of FIG. 2 has been processed in 204 to automatically identify one or more data groupings (e.g., columns) in the trial balance. Interface 312 shows data grouping column identifications 314, 316, 318, 320, 322, 324, and 326. Data grouping column identifications 314, 316 and 326 have been automatically identified using at least a portion of the process in 204 of FIG. 2. For example, as shown in Interface 312, column identification 314 identifies that the column has been identified as including account numbers. If this identification is incorrect, a user may select the dropdown menu of identification 314 to select the correct grouping column identification (or indicate to ignore the column) within a provided list of available options or input (e.g., keyboard input) a custom grouping column identification. Data grouping column identifications 318, 320, 322, and 324 have not been automatically identified (e.g., was unable to be automatically identified) and as shown for column identification 322, a user may provide the grouping column identification within a provided list of identification options or input a custom grouping column identification.

Column identification 326 identifies that the associated column has been identified as including an identifier of a leadsheet for an associated account entry of the trial balance. For example, row number 12 of the leadsheet shown in interface 312 identifies that the account named “Inventory: On Hand” belongs on the “Inventory” leadsheet. Option 328 of interface 312 allows a user to specify how to analyze the leadsheet identifier column. When identifying an associated leadsheet of an account, a user can specify whether corresponding data in the leadsheet identifier column must exactly match a predetermined leadsheet identifier or allow “best guess” fuzzy string matching to the most similar predetermined leadsheet identifier. Option 330 of interface 312 allows a user to specify how to interpret a leadsheet identifier in the leadsheet identifier column that does not match an entry in a predetermined list of leadsheets. If unmatched leadsheets are to be created, a new leadsheet is created in the event the specified leadsheet identifier in the trial balance does not match any of the predetermined list of leadsheets. Option 332 of interface 312 allows a user to specify how to round numerical numbers in the trial balance when parsing/importing the trial balance.

Returning to FIG. 2, at 208, the received trial balance is parsed/imported using the identified/specified data groupings. For example, parsing the received trial balance includes identifying one or more rows of the trial balance as including information about a financial account and obtaining from the rows, data in specific columns identified by the identified data groups to place the obtained data in a data structure of an audit software such as an audit software service provided by server 106 of FIG. 1. In some embodiments, how to parse data and/or where to place the data in an internal data structure is determined based at least in part on the identified/specified data grouping of the data. For example, by knowing which data cell of a trial balance spreadsheet belongs to which predetermined trial balance data type, desired data from the trial balance can be exported from the received trial balance. In some embodiments, the parsed data is stored in an internal data structure such as a table, database, list, or any other data structure. The internal data structure may be stored in memory and/or stored in a storage such as storage 108 of FIG. 1.

At 210, the associated leadsheet is automatically identified for one or more data entries of the received trial balance. In some embodiments, each account in a trial balance is categorized under one or more leadsheets to allow grouping of accounts under account type groups. For example, by separating accounts under different account types, one account type group may be audited/processed differently from another account type group. In some embodiments, automatically identifying the associated leadsheet includes analyzing contents of leadsheet data grouping identified in 204. For example, in 204, a leadsheet column that includes leadsheet identifiers has been identified and in 210 by examining content in the leadsheet column, the associated leadsheet of an account may be identified.

For each predetermined leadsheet, one or more character patterns (e.g., permutations of known possible identifiers) that correspond to the identifier of the leadsheet may be predetermined. In some embodiments, automatically identifying the associated leadsheet of an account includes determining whether a leadsheet identifier (e.g., located using a data grouping identified in 204) of the account matches or is sufficiently similar to any character patterns associated with the predetermined leadsheets. If a match or a close match (e.g., similarity measure meets a threshold) is found, the account may be identified as belonging to the identified leadsheet. If a match cannot be found, the account may be identified as unidentified to a specific leadsheet or identified as belonging to a new type of leadsheet corresponding to a leadsheet identifier specified for the account in the trial balance.

At 212, verification of the leadsheet identifications of accounts of the trial balance is received. For example, an automatically identified leadsheet (or indication that leadsheet is unidentified) for each account in the trial balance is indicated (e.g., provided to a user device) for display to a user. The user may verify that the associated leadsheet for an account has been correctly identified by the automated identifier, correct any identification errors, or identify any new leadsheets. For example, a user is provided information that labels/tags each account in the trial balance with identifiers of an automatically identified leadsheet or an indication that a leadsheet has not been identified for the account. If an automatically identified leadsheet identifier has been incorrectly identified or any account was unable to be automatically identified to a leadsheet, a user may be able to correct the error by specifying a correct leadsheet for the account. For example, for each identified account in the trial balance, a drop down menu or another selection menu is provided to enable a user to provide/correct/verify the associated leadsheet. In some embodiments, for each automatically identified leadsheet, a confidence indicator of the automatic identification is provided. In some embodiments, based on the indication of confidence, a confidence grouping is assigned and displayed to the user. For example, the confidence indicator is a numeric value and if the confidence indicator is within a first numeric range corresponding to the highest confidence level, the associated account is visually colored as green and if the confidence indicator is within a second numeric range corresponding to a lower confidence level, the associated account is visually colored as red. Any number or confidence groupings and associated visual indications may exist in various embodiments.

FIG. 3C is a diagram illustrating an embodiment of a user interface for providing a verification of identified leadsheets associated with accounts of a trial balance. For example, a user of user system 102 and/or 104 of FIG. 1 is provided interface 342 using data provided from server 106 of FIG. 1 to receive verification of the automatically identified leadsheets in 210 of FIG. 2. Interface 342 may be utilized to provide the verification in 212 of FIG. 2.

Interface 312 of FIG. 3B shows the accounts that are to be identified and parsed in 208 of FIG. 2 from the trial balance received in 202. For each account, the identifier of the associated leadsheet and other parsed details (e.g., account number, account name, current year balance, previous year balance, etc.) of the account are determined. When a leadsheet identifier specified in the received trial balance for an account does not exactly match an entry in a predetermined list of leadsheets, the closest matching predetermined leadsheet may be assigned to the account if a measurement of similarity between the leadsheet identifier and the identifier of the predetermined leadsheet meets a threshold. As shown in interface 342 of FIG. 3C, if a leadsheet identifier in a trial balance was matched to a predetermined leadsheet identifier based on the similarity measurement rather than an exact match, the similarity measurement (e.g., measurement of correctness) is provided to a user. For example, line 344 shows that the account of line 344 was matched to the “Fixed Assets” leadsheet even though its trial balance leadsheet identifier entry specified “Faxed Assets” (e.g., likely a typographical error) and the measurement of similarity between “Faxed Assets” and “Fixed Assets” is 94%. By selecting or hovering over the “?” icon, a user is provided an explanation of the “best guess” similarity match as well as the originally specified leadsheet identifier in the received trial balance.

Accounts that were unable to be automatically assigned a leadsheet (e.g., measurement of similarity between a leadsheet identifier in the trial balance and each preconfigured leadsheet identifier is below a threshold) are visually indicated in interface 342 as highlighted in red color. Line 346 highlighted in red shows that the “Buildings” account has not been categorized under a leadsheet. Other accounts shown in interface 342 have been highlighted in green to indicate that a leadsheet has been automatically matched. In some embodiments, an account listing is colored a different color to indicate that although a leadsheet was matched to the account automatically, the measurement of similarity between the leadsheet identifier in the trial balance and the predetermined identifier of the assigned leadsheet is within a certain range (e.g., a range that may result in an incorrect match). For example, account entries shown on an interface are shaded yellow (e.g., similarity measurement between 50-70%) to indicate user review of the automatic match is desirable.

A user may select button 348 to edit the leadsheet matched to an account, specify a leadsheet for the account, or remove the account. For example, once button 348 has been selected, a user may specify the leadsheet for line 346 by selecting a leadsheet from a list of leadsheets in a dropdown selection menu as shown in interface 360. A user may select button 350 to add a new account. A user may select button 352 to manage (e.g., add, remove, edit) the list of possible leadsheets that an account may be assigned to.

FIG. 3D is a diagram illustrating an embodiment of a user interface for managing leadsheets. For example, a user of user system 102 and/or 104 of FIG. 1 is provided interface 372 when a user selects button 352 of FIG. 3C. As shown in interface 372, a user may edit the leadsheet number, leadsheet identifier, and leadsheet category (e.g., multiple leadsheets may be assigned to the same category and leadsheets in the same leadsheet category may be audited together, audited using the same/similar procedure, and/or organized together). Additionally, a user may delete a leadsheet and add a new leadsheet.

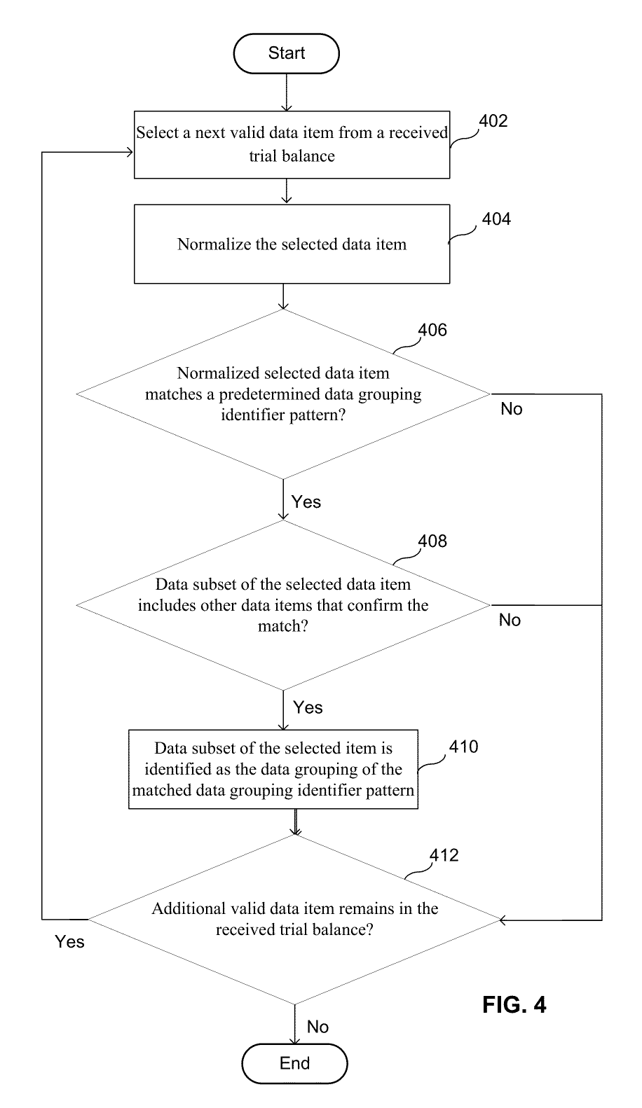

FIG. 4 is a flowchart illustrating an embodiment of a process for automatically identifying a data grouping within a received user trial balance. The process of FIG. 4 may be implemented on client device 102/104 and/or server 106 of FIG. 1. In some embodiments, the process of FIG. 4 is included in 204 of FIG. 2.

At 402, a next valid data item is selected from a received trial balance. In some embodiments, the trial balance was received in 202 of FIG. 2. In some embodiments, selecting the next valid data item includes selecting the next data item to analyze in the received trial balance. For example, the next data cell to analyze in a received trial balance spreadsheet is selected for analysis. In some embodiments, selecting the next valid data item includes selecting a next data item that matches a criteria. For example, a data item in the trial balance is valid if the data item includes content (i.e., not blank) and is not a numeric value (e.g., cell typed as numeric value or only includes numeric content). In some embodiments, the next valid data item can be only selected within a specified portion of the received trial balance. For example, the next valid data time may be only selected within the first fifteen rows of the received trial balance and each next valid data cell within these fifteen rows is identified one by one in processing order for processing on each iteration of 402 of the process of FIG. 4. The specified portion of the trial balance may be preconfigured and/or dynamically determined.

At 404, the selected data item is normalized. In some embodiments, normalizing the selected data item includes formatting content of the data item to place the selected data item in a consistent state for comparison. Normalizing the selected data item may include changing the case of one or more characters and/or removing spacing of one or more characters. For example, the selected data item is converted to all lower case and all spacing is removed.

At 406, it is determined whether the normalized selected data item matches a predetermined data grouping identifier pattern. For example, for each type of data grouping (e.g., each type of data column including a certain type data) that can be automatically identified, one or more identifier patterns are predetermined. Examples of the data grouping include the following: account name data grouping, account number data grouping, current year balance data grouping, previous year balance data grouping, associated entity/fund data grouping, current year credit data grouping, current year debit data grouping, previous year credit data grouping, previous year debit data grouping, and leadsheet identifier data grouping. In some embodiments, the received trial balance is searched to locate column heading identifiers that match predetermined identifiers of automatically detectable column data groupings.

The data grouping identifier patterns for each data grouping may include a list of character strings (e.g., in the normalized format of 404) of common identifiers of the associated data grouping that could be specified in a received trial balance (e.g., common column heading identifier in normalized format without capitalization and spaces). The data grouping identifier patterns may capture variations, deviations, alternate spellings, synonyms, and abbreviations of an identifier that identifies the data grouping. For example, for the account name data grouping, the following grouping identifier patterns are predetermined: ‘acctname’, ‘accountname’, ‘description’, ‘actname’, ‘name’, and ‘account’. In another example, for the entity/fund data grouping, the following grouping identifier patterns are predetermined: ‘fund’, ‘funds’, ‘entity’, and ‘entities’. In another example, for the account number data grouping, the following grouping identifier patterns are predetermined: ‘acctnum’, ‘actnum’, ‘number’, ‘acct#’, ‘act#’, ‘account’, ‘id’, ‘actno’, ‘acctno’, ‘accountnumber’, and ‘#’. In another example, for the leadsheet data grouping, the following grouping identifier patterns are predetermined: ‘l/s’, ‘ls’, ‘leadsheets’, ‘leadcode’, and ‘lead’. In some embodiments, the data grouping identifier patterns include a regular expression.

In the example shown in FIG. 3B, interface 312 shows that column A of the shown trial balance has been automatically identified as the account number data grouping because in cell A5 of the trial balance, the “Account Number” has been normalized to “accountnumber” and matched with an identifier pattern associated with the account number data grouping.

In some embodiments, matching the normalized data item to a predetermined data grouping identifier pattern includes determining whether the normalized data item exactly matches at least one of one or more data grouping identifier patterns of predetermined potentially identifiable data groupings. For example, a listing of identifiable data groupings is specified and for each of the identifiable data groupings, one or more corresponding data grouping identifier patterns have been specified. The normalized data item may be compared with each of the data grouping identifier patterns of all the predetermined identifiable data groupings to identify an exact match to the data grouping identifier pattern, if any.

In some embodiments, matching the normalized data item to the predetermined data grouping identifier pattern includes determining whether the normalized data item is similar to any of one or more data grouping identifier patterns of predetermined potentially identifiable data groupings. For example, a measurement of similarity between the normalized data item and each pattern of the data grouping identifier patterns of all the predetermined identifiable data groupings are determined, and if a measurement of similarity is greater than a threshold for the closest matching pattern, the closest matching pattern is determined as matching the normalized data item.

If at 406, it is determined that the normalized selected data item does match a predetermined data grouping identifier pattern, at 408, it is determined whether the data subset of the selected data item includes other data items that confirm the match. For example, it is determined whether the data subset (e.g., column) of the selected data item includes other data items that confirm that the selected data item includes an identifier of a data grouping associated with a matching identifier pattern. For example, one or more testing criteria are associated with each type of predetermined data grouping, and one or more data items (e.g., content in spreadsheet cells of a trial balance) in the data subset of the selected data item (e.g., column that includes the selected data item) are tested using the testing criteria associated with the data grouping associated with the matching identifier pattern. Examples of the testing criteria include a specification of a type of content, a type of cell, and/or actual content that is to be included in the data item being tested to confirm that the tested data item belongs in the associated data grouping. The other data items of the data subset to be tested may be selected at random within the subset, selected from a portion of the data subset after the selected data item, and/or from a preconfigured portion of the data subset. In some embodiments, determining whether the data subset of the selected data item includes other data items that confirm identifier pattern match includes determining that a predetermined number and/or percentage of tested data items in the data subset meets associated testing criteria. In some embodiments, determining whether the data subset of the selected data item includes other data items that confirm identifier pattern match includes determining that all or a predetermined portion of all items in the data subset meets an associated testing criteria.

In the example shown in FIG. 3B, interface 312 shows that column B of the shown trial balance has been automatically identified as the account name data grouping because in cell B5 of the trial balance, the “Account Name” data item has been normalized and matched to data grouping identifier pattern “accountname” of the account name data grouping. Before column B was identified as the account name data grouping, contents of cells B6, B7, and B8 were tested to determine that the contents of these cells meet an associated testing criteria that specifies that the account name data grouping includes cells with characters. In comparison, for column A of interface 312, it has been automatically identified as the account number data grouping because in cell A5 of the trial balance, the “Account Number” data item has been normalized and matched to data grouping identifier pattern “accountnumber” of the account name data grouping. Before column A was identified as the account number data grouping, contents of cells A6, A7, and A8 were tested to determine that the contents of these cells meet an associated testing criteria that specifies that the account number data grouping includes cells with numeric values.

In an alternative embodiment, step 408 is optional. For example, if at 406 it is determined that the normalized selected data item does match a predetermined data grouping identifier pattern, the process proceeds to 410.

If at 408, it is determined that the data subset of the selected data item includes other data items that confirm the match, at 410 the data subset of the selected item is identified as the data grouping of the matched data grouping identifier pattern. In some embodiments, identifying the data subset of the selected item as the data grouping includes identifying a column of the selected item as the data grouping (e.g., as one of the predetermined type of predetermined data grouping). This identified data grouping may be displayed as a column identification of a received trial balance. For example, as shown in FIG. 3B, interface 312 shows that column B of the shown trial balance has been automatically identified as the account name data grouping. In some embodiments, the identified data grouping is provided to a user for verification (e.g., verification received in 206 of FIG. 2). In some embodiments, the identified data grouping is utilized to parse data included in the data subset of the selected data item (e.g., parsed in 208 of FIG. 2).

In some embodiments, once the data grouping of the matched data grouping identifier pattern has been identified as the data grouping of the selected data item, the data grouping of the matched data grouping identifier is no longer eligible to be identified again as a data grouping of another data subset of the received trial balance. For example, in the event the process returns to 406, all data grouping identifier patterns associated with the data grouping of the matched data grouping identifier are not included in the group of data grouping identifier patterns eligible to be matched with the normalized selected data item.

If at 406, it is determined that the normalized selected data item does not match any predetermined data grouping identifier pattern, the process proceeds to 412. If at 408, it is determined that the data subset of the selected data item does not include other data items that confirm that the selected data item includes the identifier of the data grouping associated with the matching identifier pattern, the process proceeds to 412.

At 412, it is determined whether an additional valid data item remains in the received trial balance. For example, it is determined whether a next (e.g., next in traversal order) data item that matches a criteria (e.g., not blank and includes content other than numeric value in the first preconfigured number of data rows) exists in the trial balance received in 202 of FIG. 2. If at 412 it is determined that an additional valid data item remains in the received trial balance, the process returns to 402 where a next (e.g., next in traversal reading order) valid data item is selected from the received trial balance. If at 412 it is determined that an additional valid data item does not remain in the received trial balance, the process ends.

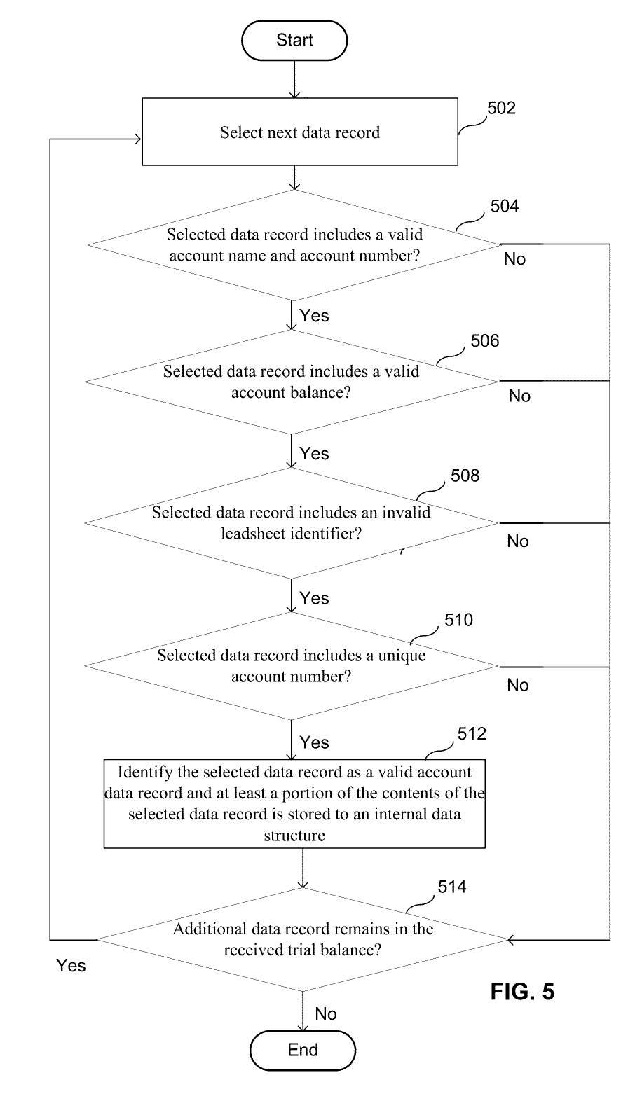

FIG. 5 is a flowchart illustrating an embodiment of a process for parsing a received trial balance using identified data groupings. The process of FIG. 5 may be implemented on server 106 and/or client device 102/104 of FIG. 1. In some embodiments, the process of FIG. 5 is included in 208 of FIG. 2.

At 502, a next data record is selected. In some embodiments, selecting the next data record includes selecting a next data row to be analyzed from a trial balance (e.g., spreadsheet) received in 202 of FIG. 2. Examples of the data record include a spreadsheet row, a line, a chart row, a table row, a database record, a data structure record, and any other data record. In some embodiments, selecting the next data record includes selecting the next data record to analyze in the received trial balance. For example, the next data row to analyze in a received trial balance spreadsheet is selected for analysis. In some embodiments, selecting the next data record includes selecting a next data record that matches a criteria. For example, a data record in the trial balance meets the criteria if the data item includes content (i.e., not blank). In some embodiments, the next data record can be only selected within a specified portion of the received trial balance. In some embodiments, selecting the next data record includes selecting a data record that is next in a predetermined ordering of data records. For example, a next data record is selected in sequential order for processing. In some embodiments, the next data record includes a plurality of data rows. For example, it is determined that information associated with a single account spans multiple rows of a trial balance spreadsheet and the multiple rows associated with the single account are selected as the next data record.

At 504, it is determined whether the selected data record includes a valid account name and account number. For example, data fields of the data record have been identified using the process of FIG. 4 and a first data field (e.g., data cell) identified as belonging to the account name data grouping (e.g., account name column) and a second data field (e.g., data cell) identified as belonging to the account number data field (e.g., account number column) are analyzed. In some embodiments, a data field of the data record includes a valid account name if the data field is not blank, includes one or more non-numeric characters, and/or includes data that is unique among other data fields of the associated data grouping (e.g., unique data in the account name spreadsheet column). In some embodiments, a data field of the data record includes a valid account number if the data field is not blank, includes only a numeric value, and/or includes data that is unique among other data fields of the associated data grouping (e.g., unique data in the account number spreadsheet column). If at 504 it is determined that the data record includes a valid account name and account number, the process proceeds to 506. If at 504 it is determined that the data record does not include a valid account name and account number, the process proceeds to 514. In an alternative embodiment, step 504 is optional.

At 506, it is determined whether the selected data record includes a valid account balance. In some embodiments, determining whether the data record includes the valid account balance includes determining whether the data record includes either a current account balance or a previous account balance. For example, data fields of the data record have been identified using the process of FIG. 4, and a data field (e.g., data cell) identified as belonging to a current year account balance grouping (e.g., current account balance column) and/or a data field (e.g., data cell) identified as belonging to the previous year account balance field (e.g., previous year account balance column), if in existence, are analyzed. In some embodiments, a data field of the data record includes a valid account balance if the data field identified as an account balance (e.g., current or previous) is not blank and includes only a numeric value (e.g., value is a number or spreadsheet cell is typed as including a numeric/monetary value). If at 506 it is determined that the data record includes a valid account balance, the process proceeds to 508. If at 506 it is determined that the data record does not include a valid account balance, the process proceeds to 514. In an alternative embodiment, step 506 is optional.

At 508, it is determined whether the selected data record includes an invalid leadsheet identifier. In some embodiments, determining whether the data record includes the invalid leadsheet identifier includes determining whether the data record includes a leadsheet identifier that does not identify to a specific leadsheet. For example, data fields of the data record have been identified using the process of FIG. 4 and a data field (e.g., data cell) of the data record identified as belonging to a trial balance identifier grouping (e.g., trial balance identifier column), if applicable, is analyzed to determine whether it includes an invalid leadsheet identifier. In some embodiments, the data field of the data record is compared with a group of one or more predetermined invalid leadsheet identifiers to determine whether the data field includes an entry from the group. If the data field includes the entry, it is determined that the data record includes an invalid leadsheet identifier. Contents of the data field may be normalized (e.g., spaces removed and case changed to lowercase) before being compared with entries of the group of invalid leadsheet identifiers. Examples of entries in the group of predetermined invalid leadsheet identifiers include: ‘l/s’, ‘ls’, ‘leadsheets’, ‘leadcode’, ‘leadcode’, and ‘lead’. For example, the predetermined invalid leadsheet identifiers identify that the selected data record does not include data about a specific account. If at 508 it is determined that the selected data record includes an invalid leadsheet identifier, the process proceeds to 510. If at 508 it is determined that the selected data record does not include an invalid leadsheet identifier, the process proceeds to 514. In alternative embodiment, step 508 is optional.

At 510, it is determined whether the selected data record includes a unique account number. For example, data fields of the data record have been identified using the process of FIG. 4 and a data field (e.g., data cell) identified as belonging to the account number data group (e.g., account number column) is analyzed to determine whether it includes a unique identifier. In some embodiments, the account number data field of the selected record includes a unique account number if the data field includes contents that are unique across all account number entries of the account number data group (e.g., unique in the account number column). In some embodiments, the account number data field of the selected record includes a unique account number if the data field includes contents that are unique across all account number entries of the account number data group that are associated with the same fund/entity (e.g., fund/entity identified by a data field of the selected data record identified as belonging to the fund/entity identifier data group column). In some embodiments, if the selected data record includes a non-unique account number, an error message is provided that a duplicated account number has been found. If at 510 it is determined that the selected data record includes a unique account number, the process proceeds to 512. If at 510 it is determined that the selected data record does not include a unique account number, the process proceeds to 514. In an alternative embodiment, step 510 is optional.

At 512, the selected data record is identified as a valid account data record and at least a portion of the contents of the selected data record is stored to an internal data structure. In some embodiments, storing the contents of the selected data record includes importing/parsing/reading one or more data fields (e.g., spreadsheet data cells) of the selected data record and storing one or more results in an internal data structure of an audit software/service (e.g., software service provided by server 106 of FIG. 1). Examples of the internal data structure include a table, database, list, or any other data structure. The internal data structure may be stored in memory and/or stored in a storage such as storage 108 of FIG. 1. In some embodiments, how to parse data fields and/or where to place the imported/parsed/read data in the internal data structure is determined based at least in part on an identified/specified data grouping associated with the data field of the selected data record to be imported/parsed/read. For example, by knowing which data cell of a trial balance spreadsheet belongs to which predetermined trial balance data type (e.g., know which column contains which data), desired data from the trial balance can be exported from the received trial balance to the internal data structure of an audit software. In some embodiments, at 512, a leadsheet associated with a selected data record is automatically identified. For example, a leadsheet identifier data grouping associated with a data field of the selected data record has been identified using the process of FIG. 4 and the account of the selected data record is assigned to a leadsheet identified by a leadsheet identifier included in the leadsheet identifier data field of the selected data record.

At 514, it is determined whether an additional data record remains. For example, it is determined whether a next (e.g., next in traversal order) data record exists in the trial balance received in 202 of FIG. 2. In some embodiments, it is determined whether an additional valid data record remains (e.g., within a specific portion of the trial balance). If at 514 it is determined that an additional data record remains in the received trial balance, the process returns to 502 where a next (e.g., next in traversal reading order) data record is selected from the received trial balance. If at 514 it is determined that an additional data record does not remain in the received trial balance, the process ends. In some embodiments, if at 514 it is determined that an additional data record does not remain in the received trial balance, using the data stored in 512 for all accounts specified in the received trial balance, it is determined whether the trial balance balances (e.g., verify that all credits equal all debits of all the accounts specified in the trial balance). If the accounts of the trial balance do not balance, an error message is provided to a user.

In some embodiments, if a data record of the received trial is not processed at 512 and reaches 514, the data record is indicated as not a valid account data record. For example, a user is provided an indication of all of the rows/lines of a trial balance that have not been parsed/stored in the internal data structure and the user is able to verify whether all rows/lines of the trial balance that include account information have been recognized by an audit software and parsed/imported by the audit software on its internal data structure.

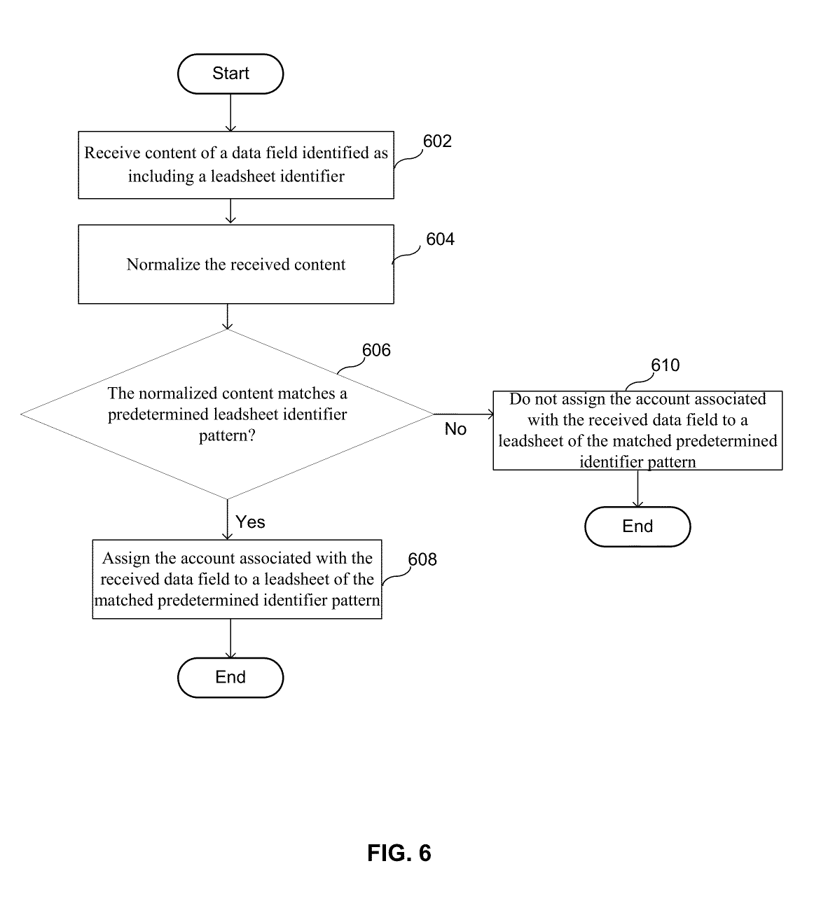

FIG. 6 is a flowchart illustrating an embodiment of a process for identifying a leadsheet. The process of FIG. 6 may be implemented on server 106 and/or client device 102/104 of FIG. 1. In some embodiments, the process of FIG. 6 is included in 210 of FIG. 2. In some embodiments, the process of FIG. 6 is included in 512 of FIG. 5 and is repeated for each iteration of 512.

At 602, content of a data field identified as including a leadsheet identifier is received. For example, a column of a received trial balance has been identified as including identifiers of leadsheets associated with associated financial accounts of the corresponding rows (e.g., identified in 204 of FIG. 2 and/or using the process of FIG. 4) and the data field included in the column is received for leadsheet identification. In some embodiments, the data field is included in the selected data record of 512 of FIG. 5.

At 604, the received content is normalized. In some embodiments, normalizing the received content includes formatting the content to place the content in a consistent state for comparison. Normalizing the content may include changing case of one or more characters and/or removing spacing or one or more characters. For example, the received content is converted to all lower case.

At 606, it is determined whether the normalized content matches a predetermined leadsheet identifier pattern. For example, for each leadsheet that has been preconfigured to be automatically identified, one or more identifier patterns are predetermined. In some embodiments, each account in a trial balance is categorized under one or more leadsheets to allow grouping of accounts under account type groups. For example, by separating accounts under different account types, one account type group and/or accounts of a particular leadsheet may be audited differently from another account type group and/or accounts of a different leadsheet. For each predetermined leadsheet, one or more identifier patterns (e.g., permutations of known possible identifiers) that correspond to the specific leadsheet may be predetermined. Examples of the leadsheet identifiers include: ‘cash’, ‘accounts receivable’, ‘inventory’, ‘accounts payable’, etc.

The leadsheet identifier patterns may include a list of character strings (e.g., in the normalized format of 604) of common identifiers of leadsheets that could be specified in a received trial balance. The leadsheet identifier patterns may capture variations, deviations, alternate spellings, synonyms, and abbreviations of an identifier that identifies a leadsheet. In some embodiments, a user may specify custom leadsheets desired by the user.

In some embodiments, matching the normalized content includes determining whether the normalized content matches or is sufficiently similar to any identifier patterns associated with predetermined leadsheets. In some embodiments, matching the normalized content to a predetermined leadsheet identifier pattern includes determining whether the normalized content matches at least one of one or more leadsheet identifier patterns of potentially identifiable leadsheets. The normalized content may be compared with each of the leadsheet identifier patterns of all the predetermined leadsheets to identify a matching leadsheet pattern, if any. In some embodiments, matching the normalized content to the predetermined leadsheet identifier pattern includes determining whether the normalized content is similar to any of one or more leadsheet identifier patterns of potentially identifiable leadsheets. For example, a measurement of similarity between the normalized content and each pattern of the leadsheet identifier patterns is determined, and if a measurement of similarity is greater than a threshold for the closest matching pattern, the closest matching pattern is determined as matching the normalized content.

If at 606, it is determined that the normalized content matches a predetermined leadsheet identifier pattern, at 608, the account associated with the received data field is assigned to a leadsheet of the matched predetermined identifier pattern. For example, if an exact match or a close similarity match (e.g., similarity measure meets a threshold) is found, the account associated with the normalized content (e.g., account specified by data record that includes the data field of the normalized content) may be identified as belonging to the identified leadsheet. In some embodiments, by identifying accounts specified in a trial balance under one or more leadsheets, the accounts are categorized by account type/category. For example, all accounts identified under the same leadsheet are accounts of the same type or category. By separating accounts under different account types, one account type group and/or accounts of a particular leadsheet may be audited/processed differently from another account type group and/or accounts of a different leadsheet. In some embodiments, a plurality of leadsheets belong to the same type/category. In some embodiments, the assigned leadsheet of the account is provided for verification at 212 of FIG. 2.

If at 606, it is determined that the normalized content does not match a predetermined leadsheet identifier pattern, at 610, the account associated with the received data field is not assigned to a leadsheet. For example, the account associated with the received data field is assigned to an unassigned leadsheet category. A user may be prompted to manually identify the leadsheet associated with the account. For example, the user manually specifies the leadsheet for the account in 212 of FIG. 2. In an alternative embodiment, rather than not assign a leadsheet to the account, a new leadsheet is created using the normalized content (e.g., added to a list of predetermined leadsheets with an associated leadsheet identifier set as the normalized content) and the account is assigned to the newly created leadsheet. This alternative embodiment may be utilized if desired by a user (e.g., option set using 330 of FIG. 3B).

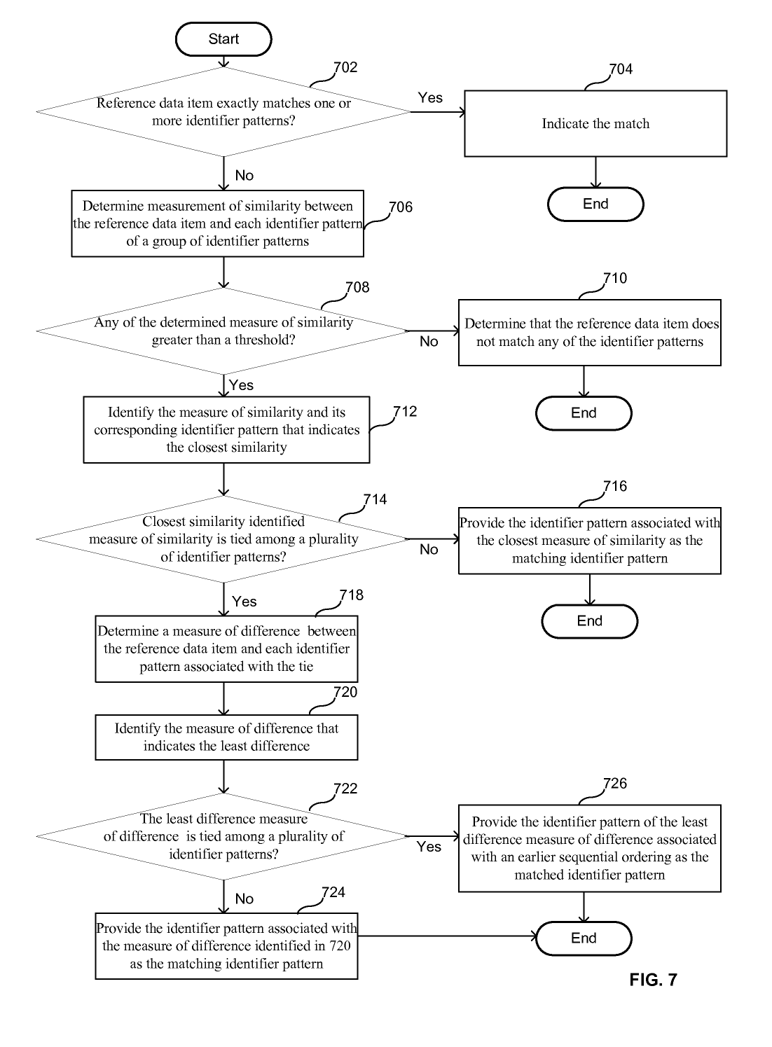

FIG. 7 is a flowchart illustrating an embodiment of a process for identifying whether a data item is similar to an identifier pattern. The process of FIG. 7 may be implemented on server 106 and/or client device 102/104 of FIG. 1. In some embodiments, the process of FIG. 7 is included in 204 and/or 210 of FIG. 2. In some embodiments, the process of FIG. 7 is included in 406 of FIG. 4. In some embodiments, the process of FIG. 7 is included in 512 of FIG. 5 and/or 606 of FIG. 6. In some embodiments, the process of FIG. 7 is utilized if fuzzy string matching is desired by a user (e.g., option 328 in FIG. 3B is selected).

At 702, it is determined whether a reference data item exactly matches one or more identifier patterns. In some embodiments, it is determined whether a selected data item matches any of one or more identifier patterns. For example, it is determined whether the reference data item (e.g., normalized content of selected data item) exactly matches (e.g., same as) a predetermined data grouping identifier pattern from a group of identifier patterns (e.g., in 406 of FIG. 4). In another example, it is determined whether the reference data item (e.g., normalized content of selected data item) exactly matches (e.g., same as) a predetermined leadsheet identifier pattern from a group of predetermined leadsheet identifier patterns (e.g., in 606 of FIG. 6).

If at 702, it is determined that an exact match is found, at 704 the match is indicated and the process ends. For example, the matched data grouping identifier pattern is identified as the matched item and the data grouping identifier of the matched identifier pattern is assigned to a data grouping of the reference data item. In another example, the matched predetermined leadsheet identifier pattern is identified as the matched pattern and account of the reference data item is assigned to the leadsheet of the matched identifier pattern.

If at 702, it is determined that an exact match is not found, at 706, a measurement of similarity between the reference data item and each identifier pattern of a group of identifier patterns is determined. For example, for each data grouping identifier pattern of a group of data grouping identifier patterns, a measurement of similarity between the reference data item (e.g., normalized) and the data grouping identifier pattern is determined. In another example, for each leadsheet identifier pattern of a group of data grouping identifier patterns, a measurement of similarity between the reference data item (e.g., normalized) and the leadsheet identifier pattern is determined.

In some embodiments, determining the measurement of similarity includes determining a Sorensen-Dice coefficient between the reference data item and each identifier pattern in a group of identifier patterns. A Sorensen-Dice coefficient may be defined as:

$$QS = \frac{2 C}{A + B} = \frac{2 \vert A ⋂ B \vert}{\vert A \vert + \vert B \vert}$$

Where “A” and “B” are the number of species in samples A and B, respectively, and “C” is the number of species shared by the two samples. “QS” is the quotient of similarity (measurement of similarity) and ranges from 0 to 1. For sets of keywords, the coefficient is defined as twice the shared information or intersection over the sum of cardinalities.

In some embodiments, when used as a measure of string similarity, the coefficient for two stings x and y using bigrams is:

$$s = \frac{2 {n}_{t}}{{n}_{x} + {n}_{y}}$$

where nₜ is the number of character bigrams present in both strings, nₓ is the number of bigrams in string x and n_{y} is the number of bigrams in string y. For example, to calculate the similarity of “equity” and “ekuiti,” the set of bigrams in each string is found. This gives results in {eq, qu, ui, it, ty} and {ek, ku, ui, it, ti}. Each set has a cardinality of 5, and the intersection of these two sets has two elements {ui, it}. Plugging these numbers into the formula above, the measurement of similarity s=(2*2)/(5+5)=0.4.

At 708, it is determined whether any of the determined measure of similarity is greater than a threshold. For example, if the measure of similarity is greater than the threshold, it is determined that the reference data item and an identifier pattern are similar enough to each other to determine that a match exists. In some embodiments, determining whether the determined measure of similarity is greater than a threshold includes determining that a calculated Sorensen-Dice coefficient is greater than the threshold (e.g., 0.7 threshold value). The threshold may be predetermined and/or dynamically determined.

If at 708, it is determined that none of the determined measure of similarity is greater than the threshold, at 710 it is determined that the reference data item does not match any of the identifier patterns and the process ends.

If at 708, it is determined that at least one of the determined measures of similarity is greater than the threshold, at 712 the measure of similarity and its corresponding identifier pattern that indicates the closest similarity (e.g., largest similarity measure value) are identified.

At 714, it is determined whether the closest similarity identified measure of similarity is tied among a plurality of identifier patterns. For example, it is determined whether the measure of similarity between the reference data item and at least one closest matching identifier pattern is the same as another measure of similarity between the reference data item and another one of the closest matching identifier pattern. In some embodiments, only a single identifier pattern can be provided as the matching identifier pattern and the tie, if applicable, must be broken.

If at 714, it is determined that the closest similarity identified measure of similarity is not tied, at 716 the identifier pattern associated with the closest measure of similarity identified in 712 is provided as the matching identifier pattern and the process ends. For example, the matched data grouping identifier pattern with the largest measure of similarity is identified as the selected identifier pattern and the data grouping identifier of the selected identifier pattern is assigned to a data grouping of the selected data item. In another example, the matched predetermined leadsheet identifier pattern with the largest measure of similarity is identified as the selected identifier pattern and account of the reference data item is assigned to the leadsheet of the selected identifier pattern.

If at 714, it is determined that the closest similarity identified measure of similarity is tied, at 718 a measure of difference is determined between the reference data item and each identifier pattern associated with the tie. An example of the measure of difference is the Levenshtein Edit Distance. In some embodiments, the Levenshtein Edit Distance is the minimum number of single-character insertions, deletions, and substitutions necessary to change one string into another. Mathematically, the Levenshtein distance between two strings a; b is given by lev_{a,b}(|a|,|b|) where

$${lev}_{a , b} ( i , j ) = \{ \begin{matrix}max ( i , j ) & if min ( i , j ) = 0 , \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + {1}_{( {a}_{i} \neq {b}_{j} )}\end{matrix} & otherwise\end{matrix} .$$

where 1_{(ai≠bj)} is the indicator function equal to 0 when aᵢ=bⱼ and equal to 1 otherwise. In some embodiments, the first element in the minimum corresponds to deletion (from a to b), the second to insertion, and the third to match or mismatch, depending on whether the respective symbols are the same. The above mathematical representation is a recursive algorithm, and the first i and j are the lengths of the strings a and b. Using the example previously discussed with the measure of similarity between “equity” and “ekuiti”, the Levenshtein distance (measure of difference) between these two string is 2. For example, two edits change “equity” into “ekuiti” (equity->equity->ekuiti).

At 720, the measure of difference that indicates the least difference (e.g., smallest Levenshtein distance) is identified.

At 722, it is determined whether the least difference measure of difference identified in 720 is tied among a plurality of identifier patterns. For example, it is determined whether the measure of difference between the reference data item and a least different identifier pattern is the same as another measure of difference between the reference data item and another least different identifier pattern.

If at 722 it is determined that the least difference measure of difference is not tied, at 724 the identifier pattern associated with the measure of difference identified in 720 is provided as the matching identifier pattern. For example, the matched data grouping identifier pattern with the largest measure of similarity and smallest measure of difference is identified as the matching item and the data grouping identifier of the matched pattern is assigned to a data grouping of the reference data item. In another example, the matched predetermined leadsheet identifier pattern with the largest measure of similarity and smallest measure of difference is identified as the matched identifier pattern and account of the reference data item is assigned to the leadsheet of the matched identifier pattern.

If at 722 it is determined that the least difference measure of difference is tied, at 726 the identifier pattern of the least difference measure of difference associated with an earlier sequential ordering is provided as the matched identifier pattern. In some embodiments, because a second tie has been created with the tied measure of difference, the identifier pattern that appears first (e.g., or last in a different embodiment) in a list of identifier patterns is selected. For example, the matched data grouping identifier pattern with the largest measure of similarity, smallest measure of difference, and appearing earlier in a listing order is identified as the selected identifier pattern and the data grouping identifier of the selected identifier pattern is assigned to a data grouping of the reference data item. In another example, the matched predetermined leadsheet identifier pattern with the largest measure of similarity, smallest measure of difference, and appearing earlier in a listing order is identified as the selected identifier pattern and account of the reference data item is assigned to the leadsheet of the selected identifier pattern. In some embodiments, rather than breaking the measure of difference tie by selecting the identifier pattern based on sequential ordering, a random identifier pattern is selected from the identifier patterns associated with the tied measure of difference identified in 720.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for automatically tagging a trial balance, comprising:
a communication interface configured to receive the trial balance in a user specific format; and
a processor coupled with the communication interface and configured to:
analyze items in the trial balance to identify a first item that likely corresponds to a first data grouping of a first data subset of the trial balance;
analyze items in the trial balance to identify a second item that likely corresponds to a second data grouping of a second data subset of the trial balance; and
provide information to display at least a portion of the first data subset of the trial balance identified as the first data grouping and to display at least a portion of the second data subset of the trial balance identified as the second data grouping to facilitate user verification of the identification of the first data subset as the first data grouping and the identification of the second data subset as the second data grouping.

2. The system of claim 1, wherein the trial balance is received in a spreadsheet file formatted in a format defined by an accountant of an entity of the trial balance.

3. The system of claim 1, wherein the first item is a first spreadsheet cell, the first data subset is a first column of the trial balance, the second item is a second spreadsheet cell, and the second data subset is a second column of the trial balance.

4. The system of claim 1, wherein the first item is a first column heading identifier and the second item is a second column heading identifier.

5. The system of claim 1, wherein the first data grouping includes one of the following: account name data grouping, account number data grouping, current year balance data grouping, previous year balance data grouping, associated entity/fund data grouping, current year credit data grouping, current year debit data grouping, previous year credit data grouping, previous year debit data grouping, and leadsheet identifier data grouping.

6. The system of claim 1, wherein analyzing items in the trial balance to identify the first item that likely corresponds to the first data grouping includes comparing a data item of the trial balance with each of a group of identifiers of the first data grouping.

7. The system of claim 1, wherein the communication interface is configured to receive a user indication that the identification of the first data subset as the first data grouping is incorrect and the first data subset is to be identified as a third data grouping.

8. The system of claim 1, wherein analyzing items in the trial balance to identify the first item that likely corresponds to the first data grouping includes comparing a data item of the trial balance with each of a group of identifiers of the first data grouping to determine whether the first item is sufficiently similar to an identifier of the first data grouping.

9. The system of claim 1, wherein analyzing items in the trial balance to identify the first item that likely corresponds to the first data grouping includes testing items in the first data subset of the trial balance to confirm that the first data subset of the trial balance corresponds to the first data grouping.

10. The system of claim 1, wherein the processor is further configured to import data records of the trial balance based at least in part on the identification of the first data subset as the first data grouping and the identification of the second data subset as the second data grouping.

11. The system of claim 10, wherein the data records of the trial balance include information corresponding to a financial account specified in a row of the trial balance.

12. The system of claim 1, wherein the processor is further configured to assign to a leadsheet one or more accounts identified in the trial balance.

13. The system of claim 12, wherein the assignment of an account of the trial balance to the leadsheet is associated with an indicator of a confidence that the account has been correctly assigned to the leadsheet.

14. The system of claim 12, wherein assigning to the leadsheet includes comparing a third data item of the leadsheet with a plurality of predetermined leadsheet identifiers.

15. The system of claim 12, wherein the communication interface is further configured to receive an identification that an account of the trial balance assigned to the leadsheet has been incorrectly assigned and that the account should be assigned to a different leadsheet.

16. The system of claim 12, wherein assigning to the leadsheet includes determining a measure of similarity between the first item and a predetermined identifier of the leadsheet and determining that the measure of similarity is greater than a threshold value.

17. The system of claim 12, wherein assigning to the leadsheet includes determining a Sorensen-Dice coefficient of the first item and a predetermined identifier of the leadsheet and determining that the Sorensen-Dice coefficient of the predetermined identifier of the leadsheet is greater than any other Sorensen-Dice coefficient between the first data item and any other predetermined leadsheet identifier.

18. The system of claim 12, wherein assigning to the leadsheet includes determining a Sorensen-Dice coefficient and a Levenshtein Edit Distance between the first item and a predetermined identifier of the leadsheet.

19. A method for automatically tagging a trial balance, comprising:
receiving the trial balance in a user specific format;
using a processor to analyze items in the trial balance to identify a first item that likely corresponds to a first data grouping of a first data subset of the trial balance;
analyzing items in the trial balance to identify a second item that likely corresponds to a second data grouping of a second data subset of the trial balance; and
providing information to display at least a portion of the first data subset of the trial balance identified as the first data grouping and to display at least a portion of the second data subset of the trial balance identified as the second data grouping to facilitate user verification of the identification of the first data subset as the first data grouping and the identification of the second data subset as the second data grouping.

20. A computer program product for automatically tagging a trial balance, the computer program product being embodied in a non-transitory computer readable storage medium and comprising computer instructions for:
receiving the trial balance in a user specific format;
analyzing items in the trial balance to identify a first item that likely corresponds to a first data grouping of a first data subset of the trial balance;
analyzing items in the trial balance to identify a second item that likely corresponds to a second data grouping of a second data subset of the trial balance; and
providing information to display at least a portion of the first data subset of the trial balance identified as the first data grouping and to display at least a portion of the second data subset of the trial balance identified as the second data grouping to facilitate user verification of the identification of the first data subset as the first data grouping and the identification of the second data subset as the second data grouping.
